(19) United States
(12) Patent Application Publication
(10) Pub. No.: US 2019/0268590 A1
(43) Pub. Date: Aug. 29, 2019

(54) CALIBRATION SYSTEM FOR DISPLAY DEVICE, DISPLAY DEVICE, IMAGE CAPTURING DEVICE, SERVER AND CALIBRATION METHOD FOR DISPLAY DEVICE

(71) Applicant: Panasonic Liquid Crystal Display Co., Ltd., Hyogo (JP)

(72) Inventors: Yoshihisa KATO, Hyogo (JP); Junichi MARUYAMA, Hyogo (JP)

(21) Appl. No.: 16/285,972

(22) Filed: Feb. 26, 2019

(30) Foreign Application Priority Data
Feb. 28, 2018 (JP) 2018-034769

(51) Int. Cl. H04N 17/00; H04N 1/00; G06T 7/00; G09G 3/36

(52) U.S. Cl. CPC H04N 17/00; H04N 1/00244; G06T 7/0002; G09G 2360/16; H04N 2201/0084; G06T 2207/30168; G09G 2320/0233; G09G 3/36

(57) ABSTRACT

A display calibration system includes: a display device; an capture device that captures the image displayed on the display device; and a server connected to the capture device through a communication path. The server acquires the image captured by the capture device through the communication path, generates correction data used to correct the display characteristic of the display device by performing arithmetic operation of the acquired image, and transmits the generated correction data to the display device or a control device connected to the display device through the communication path.

### CROSS-REFERENCE TO RELATED APPLICATION

This application claims priority from Japanese application JP 2018-034769, filed on Feb. 28, 2018. This Japanese application is incorporated herein by reference.

### TECHNICAL FIELD

The present disclosure relates to a display calibration system that calibrates a display characteristic of a display device, the display device constituting the display calibration system, a capture device, a server, and a display calibration method.

### BACKGROUND

In display devices such as a liquid crystal display (LCD), there is a variation in display characteristic. As used herein, the display characteristic is an image quality (luminance, color, and various kinds of unevenness) characteristic of each individual display device, and is a characteristic that can be adjusted by, for example, an input and output characteristic determined by a look-up table (hereinafter, also referred to as “LUT”). The display characteristic can be changed over time. For this reason, it is necessary to calibrate the display characteristic in each individual display device.

Conventionally, there has been proposed a display calibration system that calibrates the display characteristic of a display device (hereinafter, also simply referred to as “calibrating the display device”) (for example, see Unexamined Japanese Patent Publication No. 2010-81588). The display calibration system disclosed in Unexamined Japanese Patent Publication No. 2010-81588 includes a spectroscopic camera and an RGB camera, which capture a screen of the display device that is a calibration target, and a personal computer that analyzes images of the spectroscopic camera and the RGB camera to generate the LUT for image quality adjustment of the display device and updates image quality information about the display device using the generated LUT. This allows the calibration of the display device.

### SUMMARY

However, in the display calibration system of Unexamined Japanese Patent Publication No. 2010-81588, it is necessary to perform unique calibration work for each display calibration system using a plurality of dedicated calibration instruments. For this reason, there is a problem in that high cost and many man-hours are required.

The present disclosure provides a display calibration system that can calibrate a display characteristic of a display device at lower cost and fewer man hours than before, the display device constituting the display calibration system, an capture device, a server, and a display calibration method.

A display calibration system according to the present disclosure, that calibrates a display characteristic of a display device, includes: a display device that displays an image; an capture device that captures the image displayed on the display device; and a server connected to the capture device through a communication path. The server acquires the image captured by the capture device through the communication path, generates correction data used to correct the display characteristic of the display device by performing arithmetic operation of the acquired image, and transmits the generated correction data to the display device or a control device connected to the display device through the communication path.

A display device constituting above display calibration system includes: a communicator that communicates with the capture device constituting above display calibration system; a video signal generator that acquires an image transmitted from the capture device through the communicator and generates a video signal indicating the acquired image; a video signal processor including a correction data storage that acquires and stores correction data transmitted from the capture device through the communicator, the video signal processor correcting the video signal generated by the video signal generator using the correction data stored in the correction data storage; and a display panel that displays the video signal corrected by the video signal processor.

A capture device constituting above display calibration system, includes: an capture unit that captures an image displayed on the display device constituting above display calibration system; a communicator that communicates with the display device or the control device connected to the display device and the server constituting above display calibration system;

and a controller that controls the capture unit and the communicator. The controller includes: an uploader that transmits the image captured by the capture unit to the server through the communicator; and a downloader that transfers the correction data transmitted from the server through the communicator to the display device or the control device.

A server constituting above display calibration system includes: a communicator that communicates with the capture device constituting above display calibration system; and a controller that controls the communicator. The controller includes: an calculating unit that generates correction data used to correct the display characteristic of the display device constituting above display calibration system by performing arithmetic operation on the image acquired from the capture device through the communicator; and a correction data transmission unit that transmits the correction data generated by the calculating unit to the display device or the control device connected to the display device.

A display calibration method according to the present disclosure for calibrating a display characteristic of a display device includes: a display step of causing the display device to display an image; an image capturing step of causing an capture device to capture an image displayed on the display device; and a correction data transmission step of causing a server connected to the capture device through a communication path to acquire the image captured by the capture device through the communication path, generate correction data used to correct the display characteristic of the display device by performing arithmetic operation on the acquired image, and transmit the generated correction data to the display device or a control device connected to the display device through the communication path.

### BRIEF DESCRIPTION OF THE DRAWINGS

FIG. 1 is a configuration diagram illustrating a display calibration system according to an exemplary embodiment;

FIG. 2 is a block diagram illustrating a configuration of a display device in FIG. 1;

FIG. 3 is a block diagram illustrating a configuration of an capture device in FIG. 1;

FIG. 4 is a block diagram illustrating a configuration of the server in FIG. 1;

FIG. 5 is a sequence diagram illustrating basic operation of the display calibration system in FIG. 1;

FIG. 6 is a view illustrating an example in which the capture device in FIG. 1 acquires identification information about the display device by reading a bar code displayed on the display device;

FIG. 7A is a flowchart illustrating a procedure when the capture device captures a image for correction displayed on the display device in FIG. 1 from a plurality of viewpoints;

FIG. 7B is a flowchart illustrating a procedure when the server calibrates luminance unevenness using a plurality of captured images acquired by the capture device in FIG. 1;

FIG. 8A is a view illustrating a display example when the image displayed on the display device in FIG. 1 is viewed from the plurality of viewpoints;

FIG. 8B is a view illustrating an example of a graphical user interface by an imaging controller of the capture device in FIG. 1;

FIG. 9 is a view illustrating a processing flow of a calibration method in which the luminance unevenness is divided into a permanent component and a temporal component by the server in FIG. 1;

FIG. 10 is a view illustrating service moderating a sudden change in display characteristic of the display device when the display device is exchanged;

FIG. 11 is a view illustrating service that assists reproduction of appearance of the display device, which is viewed at a certain time and at a certain place by a user, at another time and at another place;

FIG. 12 is a view illustrating service predicting a change in display characteristic of the display device;

FIG. 13 is a view illustrating additional service performed by the display calibration system in FIG. 1, and illustrating a foreign matter detector;

FIG. 14A is an external view illustrating an example of a calibration jig that calibrates luminance of an capture unit of the capture device in FIG. 3;

FIG. 14B is an external view illustrating another example of the calibration jig that calibrates the luminance of the capture unit of the capture device in FIG. 3;

FIG. 14C is a view illustrating a system configuration in which a calibrated camera or a calibrated luminance meter is used as the calibration jig that calibrates the luminance or the luminance unevenness of the capture unit of the capture device in FIG. 3; and

FIG. 15 is a block diagram illustrating an example in which correction data generated by the server is downloaded to a control device connected to the display device.

### DETAILED DESCRIPTION

The following describes an exemplary embodiment of the present disclosure. The embodiment described below is merely one specific example of the present disclosure. The numerical values, shapes, materials, elements, and arrangement and connection of the elements, etc. indicated in the following embodiment are given merely by way of illustration and are not intended to limit the present disclosure. Therefore, among elements in the following embodiment, those not recited in any one of the independent claims defining the broadest inventive concept of the present disclosure are described as optional elements.

Note that the figures are schematic illustrations and are not necessarily precise depictions. Accordingly, the figures are not necessarily to scale. Moreover, in the figures, elements that are essentially the same share like reference signs. Accordingly, duplicate description is omitted or simplified.

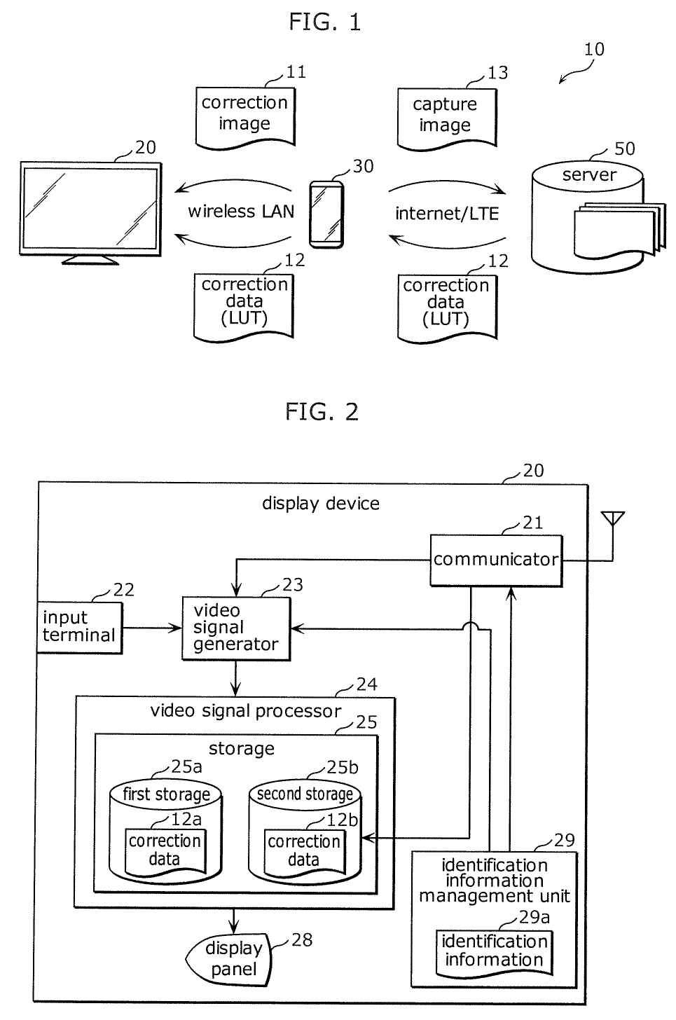

FIG. 1 is a configuration diagram illustrating display calibration system 10 according to an exemplary embodiment. As illustrated in FIG. 1, display calibration system 10 is configured with display device 20, capture device 30 and server 50.

Display device 20 is a display, such as an LCD and an organic electroluminescence (EL) display, which is a calibration target. The type of display device 20 is not limited to monochrome, gray scale, color, or the like.

Capture device 30 is a device that captures a image for correction displayed on display device 20 and transmits the image for correction to server 50. For example, capture device 30 is a portable information terminal, such as a smartphone and a tablet terminal, in which a camera is incorporated. In the exemplary embodiment, as illustrated in FIG. 1, capture device 30 causes display device 20 to display image for correction 11 by transmitting image for correction 11 to display device 20 by wireless communication such as wireless LAN, and transmits captured image 13 acquired by capturing displayed image for correction 11 to server 50 through a communication path such as the Internet and Long Term Evolution (LTE).

Server 50 acquires captured image 13 transmitted from capture device 30 through the communication path, performs arithmetic operation on acquired captured image 13 to generate correction data 12 that is the LUT used to correct the display characteristic of display device 20, and transmits generated correction data 12 to display device 20 or a control device (not illustrated) connected to display device 20 through the communication path. For example, server 50 is a computer connected to capture device 30 through the Internet or the like. Consequently, the correction data possessed by display device 20 is updated.

FIG. 2 is a block diagram illustrating a configuration of display device 20 in FIG. 1. As illustrated in FIG. 2, display device 20 includes communicator 21, input terminal 22, video signal generator 23, video signal processor 24, display panel 28 and identification information management unit 29.

Communicator 21 is a communication adapter that communicates with an external device including capture device 30. For example, communicator 21 is a communication adapter for Bluetooth (registered trademark) or wireless LAN.

Input terminal 22 is a terminal that receives a video signal. For example, input terminal 22 is a VGA terminal, a DVI terminal, or an HDMI (registered trademark) terminal.

Video signal generator 23 is a circuit that converts a video or an image input from the communicator 21 into a video signal, or relays the video signal input from input terminal 22, thereby generating the video signal to output the video signal to video signal processor 24. For example, video signal generator 23 is a graphics processor.

Video signal processor 24 includes storage 25 that acquires and holds correction data 12 and the like, which are the LUT transmitted from display capture device 30, through communicator 21. Video signal processor 24 corrects the video signal input from video signal generator 23 using pieces of correction data 12a and 12b held in storage 25, and outputs the corrected video signal to display panel 28. The pieces of correction data 12a and 12b are a set of coefficients by which each gradation value of the input signal is multiplied to convert the gradation value into an output signal. For example, the pieces of correction data 12a and 12b are data indicating a gamma curve. The pieces of correction data 12a and 12b may be data indicating an input and output characteristic independent of a pixel position (or a pixel block) of the display panel, data indicating a spatial luminance characteristic (that is, “luminance unevenness”) depending on the pixel position (or the pixel block) of the display panel, or both of them.

At this point, for example, storage 25 is a nonvolatile memory, and has a storage capacity in which at least two pieces of correction data 12a and 12b indicating different corrections are stored. More specifically, storage 25 includes first storage 25a that stores previously-provided correction data 12a (that is, an initial value at time of shipment from a factory) and a second storage 25b that stores correction data 12b (that is, correction data after the shipment from the factory) transmitted from capture device 30. Video signal processor 24 corrects the video signal input from video signal generator 23 using the correction data obtained by multiplying correction data 12a held in first storage 25a by correction data 12b held in second storage 25b, and outputs the corrected video signal to display panel 28.

Based on an instruction from a user or the like, video signal processor 24 can directly output the video signal to display panel 28 without correcting the video signal input from video signal generator 23 using the pieces of correction data 12a and 12b held in storage 25.

Display panel 28 is a display panel that displays the video signal input from video signal processor 24, and includes a timing controller (TCON), a data signal line driver, an address signal line driver, and a liquid crystal panel.

Identification information management unit 29 is a processor, which holds identification information 29a individually identifying display device 20 and presents held identification information 29a to an outside through communicator 21 or display panel 28 when receiving a presentation request. For example, identification information management unit 29 is implemented with a microcomputer including a nonvolatile memory in which identification information 29a is stored. Specifically, upon receiving the request to present identification information 29a in response to a user's instruction from a remote controller (not illustrated) or the like, identification information management unit 29 (1) notifies video signal generator 23 of identification information 29a so as to issue an instruction to video signal generator 23 to transmit identification information 29a by visible-light communication using display panel 28, (2) notifies video signal generator 23 of identification information 29a so as to issue an instruction to video signal generator 23 to display identification information 29a on the display panel 28 with the bar code, or (3) notifies communicator 21 of identification information 29a so as to issue an instruction to communicator 21 to transmit identification information 29a through communicator 21 by wireless communication.

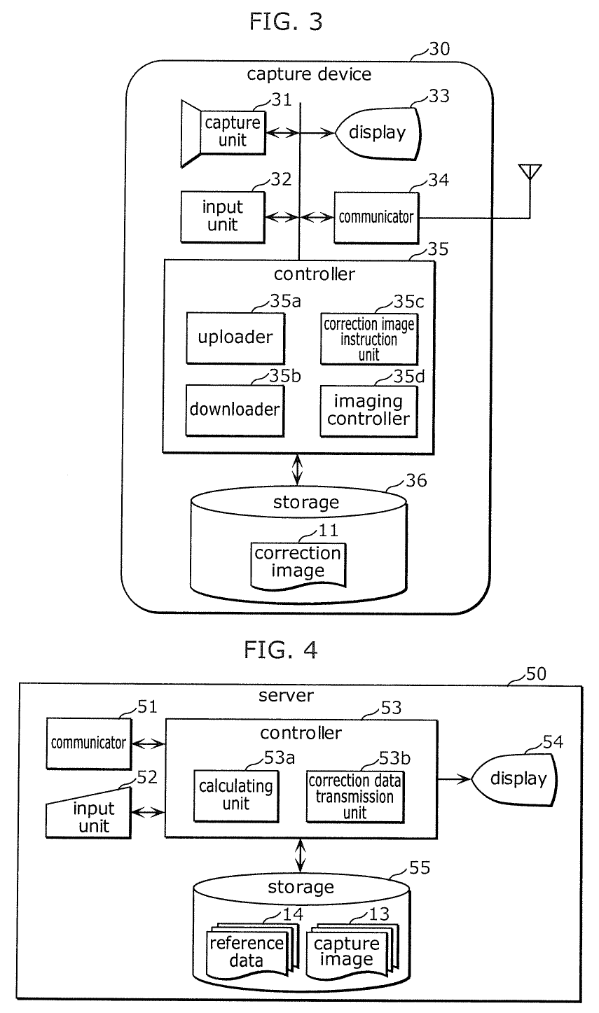

FIG. 3 is a block diagram illustrating a configuration of capture device 30 in FIG. 1. As illustrated in FIG. 3, capture device 30 includes capture unit 31, input unit 32, display 33, communicator 34, controller 35, and storage 36. As described above, capture device 30 is the portable information terminal such as a smartphone and a tablet terminal. Thus, capture unit 31, input unit 32, display 33, communicator 34, controller 35, and storage 36 are integrated and accommodated in one small portable casing.

In the exemplary embodiment, capture unit 31 is a camera that is used to capture an image for correction displayed on display device 20. For example, capture unit 31 is a color CCD or a CMOS image sensor incorporated in the portable information terminal. The image for correction is an image used to calibrate display device 20.

Input unit 32 is an input device, such as a touch panel and a button, which receives the instruction from the user.

Display 33 is a display such as an LCD.

Communicator 34 is a communication adapter that communicates with an external device including display device 20. For example, communicator 34 may be a communication adapter for Bluetooth (registered trademark) or wireless LAN or a group of different kinds of communication adapters.

Controller 35 is a processor that exerts various functions as capture device 30 by controlling capture unit 31, input unit 32, display 33, communicator 34, and storage 36. Specifically, controller 35 is a control circuit including a memory in which a program such as an application is stored, a processor that executes the program, and various input and output ports, and controller 35 includes uploader 35a, downloader 35b, image for correction instruction unit 35c, and imaging calibrator 35d as a functional component exerted by executing the program using the processor.

Uploader 35a transmits (that is, uploads) captured image 13 captured by capture unit 31 to server 50 through communicator 21.

Downloader 35b transfers (that is, downloads) correction data 12 transmitted from server 50 through communicator 21 to display device 20 or the control device (in the exemplary embodiment, display device 20) connected to display device 20.

Image for correction instruction unit 35c transmits image for correction 11 stored in storage 36 to display device 20 through communicator 34, and causes display device 20 to display image for correction 11.

Imaging controller 35d controls capture unit 31 such that capture unit 31 captures an image displayed on display device 20 from a plurality of viewpoints. At this point, imaging controller 35d provides a graphical user interface that supports the image capturing from the plurality of viewpoints to the user through display 33.

According to an instruction from the user through input unit 32, controller 35 (1) acquires the identification information about display device 20 by receiving the identification information from display device 20 through communicator 34, (2) acquires the identification information about display device 20 by receiving the visible-light communication from display device 20 through capture unit 31, or (3) acquires the identification information about display device 20 by code analysis after the bar code displayed on display device 20 is captured by capture unit 31. In the case where the identification information about display device 20 is acquired, uploader 35a also transmits the identification information acquired from display device 20 to server 50 when transmitting captured image 13 to server 50.

Storage 36 functions not only as a image for correction storage in which image for correction 11 is stored, but also as a memory in which various images and various pieces of data are stored. For example, storage 36 is a nonvolatile memory.

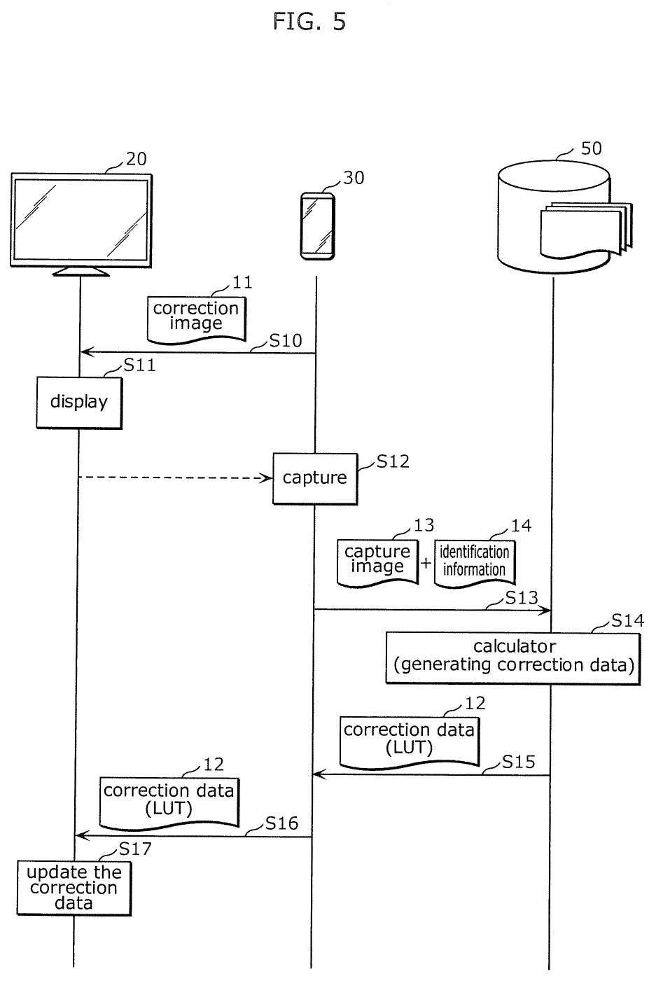

FIG. 4 is a block diagram illustrating a configuration of server 50 in FIG. 1. As illustrated in FIG. 4, server 50 includes communicator 51, input unit 52, controller 53, display 54, and storage 55. As described above, for example, server 50 is a computer device connected to capture device 30 through the Internet or the like.

Communicator 51 is a communication adapter that communicates with an external device including capture device 30. For example, communicator 51 may be a communication adapter for wired or wireless LAN or the Internet, or a group of different types of communication adapters.

Input unit 52 is an input device that receives the instruction from the user. For example, input unit 52 is a keyboard or a mouse.

Display 54 is a display such as an LCD.

Controller 53 is a processor that exerts a function as a server that calibrates display device 20 by controlling communicator 51, input unit 52, display 54, and storage 55. Specifically, controller 53 is a control circuit including a memory in which a program is stored, a processor that executes the program, and various input and output ports, and includes an calculating unit 53a and a correction data transmission unit 53b as a functional component exerted by executing the program using the processor.

Calculating unit 53a acquires captured image 13 captured by capture device 30 through communicator 51, and performs the arithmetic operation on acquired captured image 13, thereby generating correction data 12 that is the LUT used to correct the display characteristic of display device 20. At this point, when acquiring identification information 29a from capture device 30, calculating unit 53a generates correction data 12 while correlating correction data 12 with acquired identification information 29a.

Specifically, as the luminance calibration, calculating unit 53a performs the arithmetic operation on the luminance of at least one of representative points of captured image 13 acquired from capture device 30 using a reference value of the luminance at the representative point, thereby generating correction data 12. At this point, calculating unit 53a selects a part of a plurality of pieces of reference data 14 corresponding to identification information 29a acquired from capture device 30 from the plurality of pieces of reference data 14 stored in storage 55, and applies the arithmetic operation to captured image 13 acquired from capture device 30 with using the selected part of the plurality of pieces of reference data 14, thereby generating correction data 12. For example, reference data 14 used at this point is the image identical to image for correction 11, which is transmitted to display device 20 by capture device 30 and displayed on display device 20. Thus, calculating unit 53a performs the arithmetic operation on the luminance of at least one representative point of captured image 13 acquired from capture device 30 using as a reference value the luminance corresponding to the representative point of the image for correction that is reference data 14, thereby generating the correction data.

As the calibration of luminance unevenness, calculating unit 53a generates correction data 12 by performing the arithmetic operation to calculate spatial luminance unevenness on captured image 13 acquired from capture device 30. At this point, calculating unit 53a generates correction data 12 by performing the arithmetic operation on the image acquired from capture device 30 using reference data 14 stored in storage 55. For example, reference data 14 used at this point is an initial value indicating the spatial distribution of the luminance of display device 20. Thus, calculating unit 53a generates correction data 12 by calculating the spatial luminance unevenness of the image acquired from capture device 30 based on the initial value indicated by reference data 14.

When acquiring, from capture device 30, a plurality of captured images 13 captured from the plurality of viewpoints by capture device 30, calculating unit 53a synthesizes the plurality of obtained captured images 13, and generates correction data 12 using the image obtained by the synthesis.

Correction data transmission unit 53b transmits (that is, downloads) correction data 12 generated by calculating unit 53a toward display device 20 or the control device (in the exemplary embodiment, display device 20) connected to display device 20 through communicator 51.

In an automatic manner or according to an instruction from the user through input unit 32 or input unit 52, controller 53 repeatedly accumulates captured image 13 acquired from capture device 30 in storage 55 while correlating captured image 13 with display device 20 together with the time information indicating acquired date and time. In this case, based on accumulated captured image 13 and the time information, controller 53 displays aging of the display characteristic of display device 20 on display 54, or predicts a change in display characteristic of display device 20.

Storage 55 is a memory in which various pieces of data including reference data 14 are stored. For example, storage 55 is a nonvolatile memory. For example, reference data 14 is data, which is acquired by server 50 from a database provided by a manufacturer of display device 20 and stored in storage 55. Storage 55 is not necessarily a local storage device of server 50, but may be a remote storage device accessed from server 50 through the communication path such as the Internet.

Operation of display calibration system 10 of the exemplary embodiment having the above configuration will be described below.

FIG. 5 is a sequence diagram illustrating basic operation (that is, a method for calibrating display device 20) of display calibration system 10 in FIG. 1. At this point, operation procedures and communication exchanges of display device 20, capture device 30 and server 50 are illustrated in FIG. 5.

In capture device 30, according to the instruction from the user through input unit 32, image for correction instruction unit 35c of controller 35 reads image for correction 11 from storage 36, and transmits read image for correction 11 to display device 20 through communicator 34 (S10). Incidentally, a plurality of images for correction 11 corresponding to various purposes or accuracy are stored in storage 36, and image for correction instruction unit 35c may read image for correction 11 selected from the plurality of images for correction 11 from storage 36 according to the user's instruction from the input unit 32, and transmit selected image for correction 11 to display device 20.

Subsequently, in display device 20, image for correction 11 received through communicator 21 is converted into the video signal by video signal generator 23, and the converted video signal is transmitted to video signal processor 24. In video signal processor 24, the input video signal is corrected using correction data 12a stored in storage 25, transmitted to display panel 28, and displayed (display step S11). In the correction, typically, the correction is performed using correction data 12a (that is, the initial value at the time of the shipment from the factory). Alternatively, the correction may be performed using correction data obtained by multiplying correction data 12a held in first storage 25a by the correction data 12b (that is, correction data after factory shipment) held in second storage 25b. Alternatively, the video signal input from video signal generator 23 may be output without performing the correction, namely, the video signal may directly be output to display panel 28.

Subsequently, in capture device 30, capture unit 31 captures image for correction 11 displayed on display device 20 (capture step S12). When the luminance calibration is performed, the processing steps (S10 to S12) of transmitting the plurality of images for correction 11 with different luminances from capture device 30 to display device 20, displaying the plurality of images for correction 11 on display device 20, capturing image for correction 11 displayed on display device 20 and holding image for correction 11 using capture device 30 (temporarily storing image for correction 11 in storage 36) are repeated with respect to the plurality of images for correction 11.

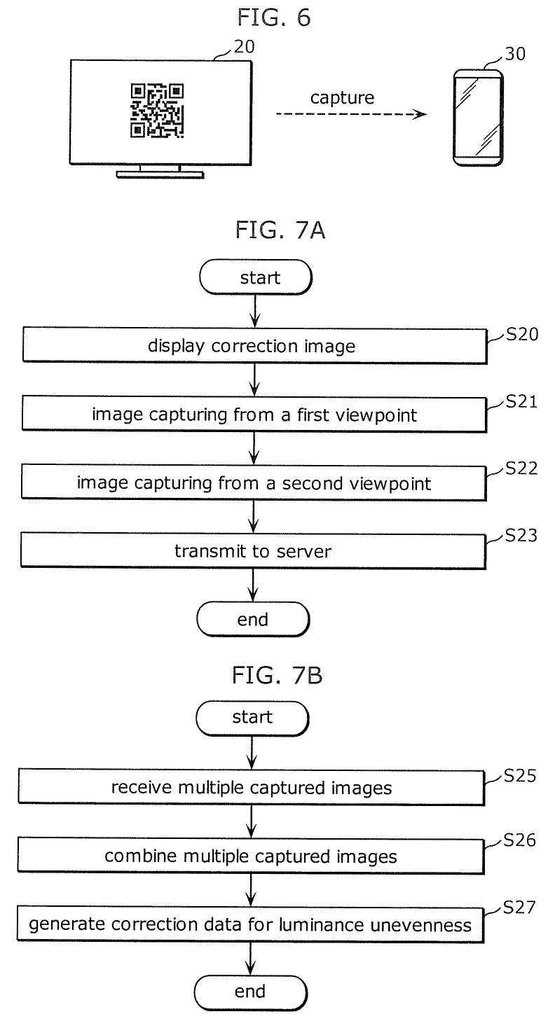

Subsequently, uploader 35a of capture device 30 transmits captured image 13 obtained by the image capturing of capture unit 31 to server 50 through communicator 21 (S13). At this point, in the case where capture device 30 acquires the identification information of display device 20 by wireless communication, visible-light communication, or reading of the bar code displayed on display device 20 as illustrated in FIG. 6, uploader 35a also transmits the identification information acquired from display device 20 to server 50 when transmitting captured image 13 to server 50.

In server 50 that acquires captured image 13 transmitted from capture device 30, calculating unit 53a performs arithmetic operation on acquired captured image 13 to generate correction data 12 that is the LUT used to correct the display characteristic of display device 20 (S14). At this point, when acquiring identification information 29a from capture device 30, calculating unit 53a generates correction data 12 while correlating correction data 12 with acquired identification information 29a.

Specifically, as the luminance calibration, calculating unit 53a performs the arithmetic operation on the luminance of at least one of representative points of captured image 13 acquired from capture device 30 using a reference value of the luminance at the representative point, thereby generating correction data 12. More specifically, calculating unit 53a performs arithmetic operation (for example, division) on the luminance of at least one representative point of captured image 13 acquired from capture device 30 using as a reference value the luminance corresponding to the representative point of the image for correction that is reference data 14 stored in storage 55, thereby generating the correction data.

When the plurality of captured images 13 having different luminances are acquired from capture device 30, calculating unit 53a calculates the correction coefficient for each of the plurality of different luminances. That is, calculating unit 53a calculates the correction coefficient for one luminance (that is, a gradation value) by dividing the luminance of the reference value by the luminance at the representative point of one captured image 13 acquired from capture device 30. This processing is repeatedly performed on the plurality of captured images 13 (that is, a plurality of gradation values) acquired from capture device 30. Calculating unit 53a calculates the correction coefficient for each of all the luminances (that is, gradation values) by interpolating the plurality of obtained correction coefficients, and corrects a group of the calculated correction coefficients as correction data 12 used to correct the luminance.

As the calibration of luminance unevenness, calculating unit 53a generates correction data 12 by performing the arithmetic operation to calculate spatial luminance unevenness on captured image 13 acquired from capture device 30. For example, an average value of pixel values (or pixel blocks) of captured image 13 is calculated, and the group of the correction coefficients obtained by dividing the calculated average value by each pixel value (or the average pixel value of the pixel block) is calculated as correction data 12 used to correct the luminance unevenness. In the calibration of the luminance unevenness using reference data 14, calculating unit 53a generates correction data 12 by calculating the spatial luminance unevenness of the image acquired from capture device 30 based on the initial value indicated by reference data 14 stored in storage 55. Which one of the luminance calibration, the calibration of the luminance unevenness, and both of them is performed depends on a previous setting of the user through input unit 32.

Subsequently, correction data transmission unit 53b of server 50 transmits correction data 12 generated by calculating unit 53a to display device 20 or the control device (in the exemplary embodiment, display device 20) connected to display device 20 through communicator 51 (correction data transmission step S15).

In capture device 30 that receives correction data 12 transmitted from server 50, downloader 35b transfers correction data 12 received from server 50 to display device 20 or the control device (in the exemplary embodiment, display device 20) connected to display device 20 through communicator 34 (S16).

In display device 20, correction data 12 transmitted from capture device 30 is received by communicator 21, and overwritten and stored in second storage 25b by video signal processor 24 (S17). Consequently, correction data 12b of second storage 25b is updated.

In the case where image for correction 11 is displayed by outputting the video signal input from video signal generator 23 to display panel 28 without correcting the video signal using video signal processor 24 in step S11, in display device 20, correction data 12 transmitted from capture device 30 may be overwritten and stored in first storage 25a by video signal processor 24.

After the calibration is completed, in display device 20, video signal processor 24 corrects the video signal input from video signal generator 23 using the correction data obtained by multiplying correction data 12a held in first storage 25a by correction data 12b held in second storage 25b, and outputs the corrected video signal to display panel 28. In this way, display device 20 performs the display reflecting the luminance calibration, the calibration of luminance unevenness, or both of them by capture device 30.

As described above, display calibration system 10 of the exemplary embodiment is the system that calibrates the display characteristic of display device 20, and display calibration system 10 includes display device 20 that displays the image, capture device 30 that captures the image displayed on display device 20, and server 50 connected to capture device 30 through the communication path, server 50 acquiring the image captured by capture device 30 through the communication path, generating correction data 12 used to correct the display characteristic of display device 20 by performing the arithmetic operation on the acquired image, and transmitting generated correction data 12 to display device 20 or the control device connected to display device 20 through the communication path.

Consequently, at a site where display device 20 is placed, it is only necessary to capture the image displayed on display device 20 using capture device 30 and transmit the captured image to server 50, so that display device 20 can be calibrated by the simple operation in conjunction with the server 50. Because server 50 can perform the calibration common to the plurality of display devices 20, calibration instrument cost necessary for each display device 20 is reduced as compared with the case where a plurality of dedicated calibration instruments are installed at each site where the calibration is performed. Thus, display calibration system 10 that can calibrate the display characteristic of display device 20 at lower cost and fewer man hours than before is achieved. The calibration service having high added value and high accuracy can be achieved by the calibration in which big data and high arithmetic performance on server 50 are used.

At this point, capture device 30 may be a portable information terminal including capture unit 31.

Consequently, capture device 30 is implemented with the portable information terminal such as a widely spread smartphone, so that display device 20 can be calibrated only by installing the application with no use of special hardware at the site where display device 20 is placed.

Server 50 generates correction data 12 by performing the arithmetic operation on the luminance of at least one representative point of the image acquired from capture device 30 using the reference value of the luminance at the representative point.

Consequently, at the site where display device 20 is placed, the luminance calibration is performed on display device 20 only by operating capture device 30.

Server 50 generates correction data 12 by performing the arithmetic operation to calculate the spatial luminance unevenness on the image acquired from capture device 30.

Consequently, at the site where display device 20 is placed, the calibration of the luminance unevenness is performed on display device 20 only by operating capture device 30.

Capture device 30 transmits image for correction 11 to display device 20, display device 20 acquires and displays image for correction 11 transmitted from capture device 30, and capture device 30 captures image for correction 11 displayed on display device 20.

Display device 20 is calibrated after image for correction 11 held by capture device 30 is displayed on display device 20, so that any image for correction 11 can be selected on the capture device 30 side as the image for correction used in the calibration.

Display device 20 acquires correction data 12 from server 50 through the communication path, and corrects and displays the input video signal using acquired correction data 12.

Consequently, correction data 12 held by display device 20 is updated by correction data 12 obtained by the calibration, and display device 20 utilizes updated correction data 12.

Server 50 holds reference data 14 indicating the display characteristic of display device 20, and performs the arithmetic operation on the image acquired from capture device 30 using reference data 14, thereby generating correction data 12.

Consequently, the calibration is performed using not only the image obtained by capture device 30 but also the reference information, such as the reference data, which is held by the manufacturer of display device 20, so that the calibration can be implemented with high accuracy.

Display device 20 presents identification information 29a identifying display device 20, capture device 30 acquires identification information 29a presented by display device 20, and server 50 acquires identification information 29a from capture device 30, and generates correction data 12 while correlating correction data 12 with acquired identification information 29a.

Consequently, correction data 12 is held and managed while correlated with each display device 20 in server 50, so that the high value added service such as calibration service over a long term for each display device 20 can be provided.

Display device 20 presents identification information 29a by transmitting identification information 29a by visible-light communication, displaying identification information 29a with the bar code, or transmitting identification information 29a by wireless communication.

Consequently, identification information 29a of display device 20 is read by the image capturing or the communication, there is no need to manually read and input identification information 29a.

Server 50 holds the plurality of reference data 14, selects a part of the plurality of pieces of reference data 14 based on identification information 29a acquired from capture device 30, and generates correction data 12 by performing the arithmetic operation on the image acquired from capture device 30 using the selected part of the pieces of reference data 14.

Consequently, the correction data can accurately be created by extracting and using reference data 14 related to the target display device from reference data 14 related to many display devices.

Display device 20 constituting display calibration system 10 includes communicator 21 that communicates with capture device 30, video signal generator 23 that acquires the image transmitted from capture device 30 through communicator 21 and generates the video signal indicating the acquired image, video signal processor 24 that includes storage 25 as the correction data storage, which acquires correction data 12 transmitted from capture device 30 through communicator 21 and stores the correction data 12, and corrects the video signal generated by video signal generator 23 using correction data 12 stored in the correction data storage, and display panel 28 that displays the video signal corrected by video signal processor 24.

Consequently, display device 20 is achieved in which the display characteristic is calibrated at lower cost and fewer man-hours though capture device 30 that is the portable information terminal such as a smartphone.

Storage 25 storing data for collection has a storage capacity in which at least two pieces of correction data 12a and 12b indicating different corrections are stored.

Consequently, even if the state is to be returned to the state before the calibration for some reason after the calibration, restoration can be performed using one of the two pieces of correction data 12a and 12b for backup use or the like, and highly-functional display device 20 is achieved.

Storage 25 includes first storage 25a in which previously provided correction data 12a is stored and second storage 25b in which correction data 12b transmitted from capture device 30 is stored.

Consequently, first storage 25a is used to store the initial value and second storage 25b is used for the update, whereby the display characteristic can always be restored to the initial state, and display device 20 having excellent convenience is achieved. As an example, first storage 25a may be configured with a read-only and non-rewritable read only memory (ROM), and the second storage 25b may be configured with a rewritable random access memory (RAM).

Video signal processor 24 outputs the video signal generated by the video signal generator 23 without correcting the video signal using the pieces of correction data 12a and 12b stored in storage 25, and the display panel 28 displays the video signal that is output from video signal processor 24 without performing the correction.

This allows the display of the video signal that does not reflect the correction data, so that display device 20 can be calibrated after the image is displayed with the original display characteristic of display device 20. Thus, the correction data that can directly correct the original display characteristic of display device 20 is generated without being affected by the preceding correction data.

Capture device 30 of the exemplary embodiment includes capture unit 31 that captures the image displayed on display device 20, communicator 34 that communicates with display device 20 or the control device connected to display device 20 and server 50, and controller 35 that controls capture unit 31 and communicator 34, and controller 35 includes uploader 35a that transmits the image captured by capture unit 31 to server 50 through communicator 21 and downloader 35b that transfers correction data 12 transmitted from server 50 through communicator 21 to display device 20 or the control device.

Consequently, capture device 30 which is used in display calibration system 10 that can calibrate the display characteristic of display device 20 at lower cost and fewer man-hours than before is achieved.

Server 50 of the exemplary embodiment includes communicator 51 that communicates with capture device 30 and controller 53 that controls communicator 51, and controller 53 includes calculating unit 53a that generates correction data 12 used to correct the display characteristic of display device 20 by performing the arithmetic operation on the image acquired from capture device 30 through communicator 51 and correction data transmission unit 53b that transmits correction data 12 generated by calculating unit 53a to display device 20 or the control device connected to display device 20.

Consequently, server 50 which is used in display calibration system 10 that can calibrate the display characteristic of display device 20 at lower cost and fewer man-hours than before is achieved. The calibration service having high added value and high accuracy can be achieved by the calibration in which big data and high arithmetic performance on server 50 are used.

The method for calibrating display device 20 of the exemplary embodiment includes the display step of causing display device 20 to display the image, the image capturing step S12 of causing capture device 30 to capture the image displayed on display device 20, and the correction data transmission step S15 of causing server 50 connected to capture device 30 through the communication path to acquire the image captured by capture device 30 through the communication path, generate correction data 12 used to correct the display characteristic of display device 20 by performing the arithmetic operation on the acquired image, and transmit generated correction data 12 to display device 20 or the control device connected to display device 20 through the communication path.

Consequently, at a site where display device 20 is placed, it is only necessary to capture the image displayed on display device 20 using capture device 30 and transmit the captured image to server 50, so that display device 20 can be calibrated by the simple operation in conjunction with the server 50. Because server 50 can perform the calibration common to the plurality of display devices 20, calibration instrument cost necessary for each display device 20 is reduced as compared with the case where the dedicated calibration instrument is installed at each site where the calibration is performed. Thus, the display characteristic of display device 20 can be calibrated at lower cost and fewer man-hours than before. The calibration service having high added value and high accuracy can be achieved by the calibration in which big data and high arithmetic performance on server 50 are used.

The characteristic calibration performed by display calibration system 10 of the exemplary embodiment will be described below in detail.

The calibration of the luminance unevenness using the images captured from the plurality of viewpoints will be described as a first characteristic calibration performed by display calibration system 10.

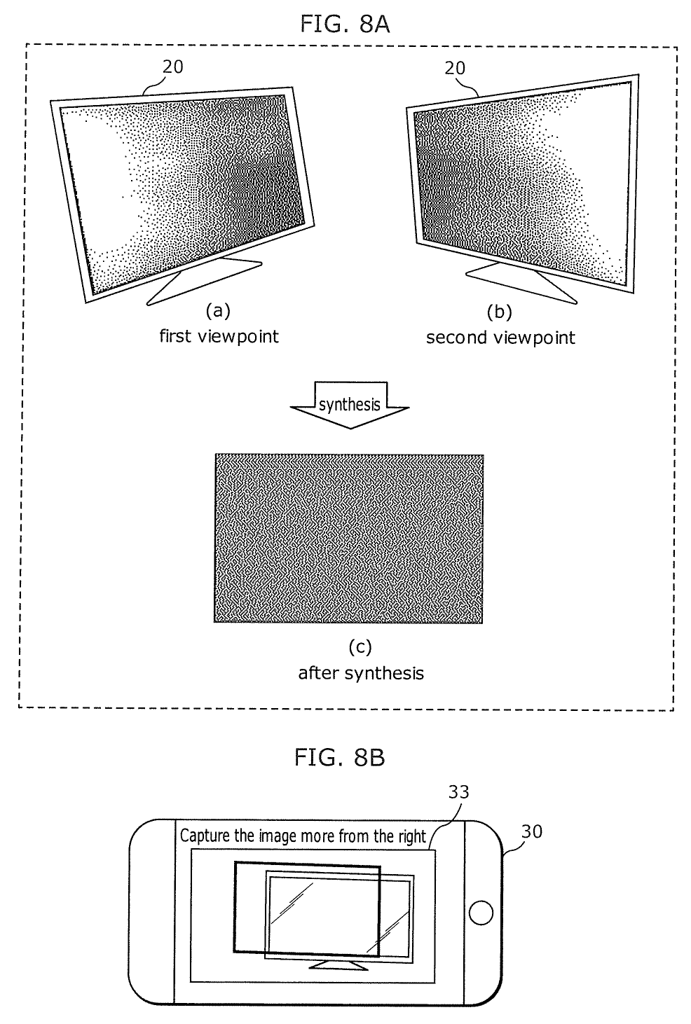

FIGS. 7A and 7B are flowcharts illustrating a procedure of calibrating the luminance unevenness using the images captured from the plurality of viewpoints. Specifically, FIG. 7A is the flowchart illustrating the procedure when capture device 30 captures image for correction 11 displayed on display device 20 in FIG. 1 from the plurality of viewpoints. FIG. 7B is the flowchart illustrating the procedure when server 50 calibrates the luminance unevenness using the plurality of captured images acquired by capture device 30 in FIG. 1. FIG. 8A is a view illustrating a display example when the image displayed on display device 20 in FIG. 1 is viewed from the plurality of viewpoints. FIG. 8B is a view illustrating an example of the graphical user interface by imaging controller 35d of capture device 30 in FIG. 1.

Image for correction 11 in which all the pixels have the identical pixel value is displayed on display device 20 (S20 in FIG. 7A).

Subsequently, capture device 30 performs the image capturing from a first viewpoint (S21 in FIG. 7A, a part (a) of FIG. 8A). Specifically, as illustrated in FIG. 8B, imaging controller 35d displays an image on display 33, the image prompting the user to capture image for correction 11 displayed on display device 20 from the first viewpoint (for example, in obliquely left front of display device 20) among the plurality of viewpoints. More specifically, imaging controller 35d displays a guide indicating a frame of display panel 28 in the case where display device 20 is viewed from the first viewpoint, a moving image of a target object to be captured by capture unit 31, and a guidance message on display 33 of capture device 30 while superimposing the guide, the moving image, and the guidance message on one another. As used herein, the guidance message is, for example, “Capture the image from a direction in which the frame of the screen of the display device is matched with the guide”, “Capture the image more from the right”, and the like. The user performs the image capturing while matching the frame of the screen of display device 20 with the guide on display 33. Then, imaging controller 35d stores captured image 13 obtained by the image capturing in storage 36.

Subsequently, capture device 30 performs the image capturing from a second viewpoint (S22 in FIG. 7A, a part (b) of FIG. 8A). Specifically, imaging controller 35d displays an image on display 33, the image prompting the user to capture image for correction 11 displayed on display device 20 from the second viewpoint (for example, in obliquely right front of display device 20) among the plurality of viewpoints. In this case, imaging controller 35d displays a guide illustrating the frame of display panel 28 in the case where display device 20 is viewed from the second viewpoint as the guide displayed on display 33 of capture device 30. The user performs the image capturing while matching the frame of the screen of display device 20 with the guide on display 33. Then, imaging controller 35d stores captured image 13 obtained by the image capturing in storage 36.

The image capturing from such different viewpoints is not limited to the image capturing from two directions, but the image may be captured from three or more directions.

When a plurality of captured images 13 obtained by the image capturing from the plurality of viewpoints under the guidance of imaging controller 35d using the graphical user interface are stored in storage 36 in this way, uploader 35a of capture device 30 reads the plurality of captured images 13 from storage 36 and transmits the plurality of captured images 13 to server 50 through communicator 21 (S23 in FIG. 7A).

In server 50, communicator 51 receives the plurality of captured images 13 transmitted from capture device 30, and stores the plurality of captured images 13 in storage 55 (S25 in FIG. 7B). Calculating unit 53a of server 50 reads the plurality of captured images 13 from storage 55, and generates the correction data using the plurality of read captured images 13 (S26 and S27 in

FIG. 7B, a part (c) of FIG. 8A). Specifically, calculating unit 53a adds (or averages) the pixel value of the identical pixel position to the plurality of captured images 13 to synthesize the plurality of captured images 13 (S26 in FIG. 7B), and generates correction data 12 used to correct the luminance unevenness by performing the arithmetic operation on the image obtained by the synthesis (S27 in FIG. 7B, the part (c) of FIG. 8A).

In this way, in the calibration of the luminance unevenness using the plurality of images, capture device 30 captures the image displayed on display device 20 from the plurality of viewpoints, and server 50 acquires the plurality of images captured by capture device 30 from the plurality of viewpoints, synthesizes the plurality of acquired images, and generates correction data 12 using the image obtained by the synthesis.

Consequently, correction data 12 is generated by synthesizing and using the plurality of images captured from the plurality of viewpoints, so that the luminance unevenness of display device 20 can be calibrated while the influence of noise such as moire, beat, and external light is prevented.

A method in which the luminance unevenness of display device 20 is calibrated while the luminance unevenness is divided into a permanent component and a temporal component will be described below as a second characteristic calibration performed by display calibration system 10.

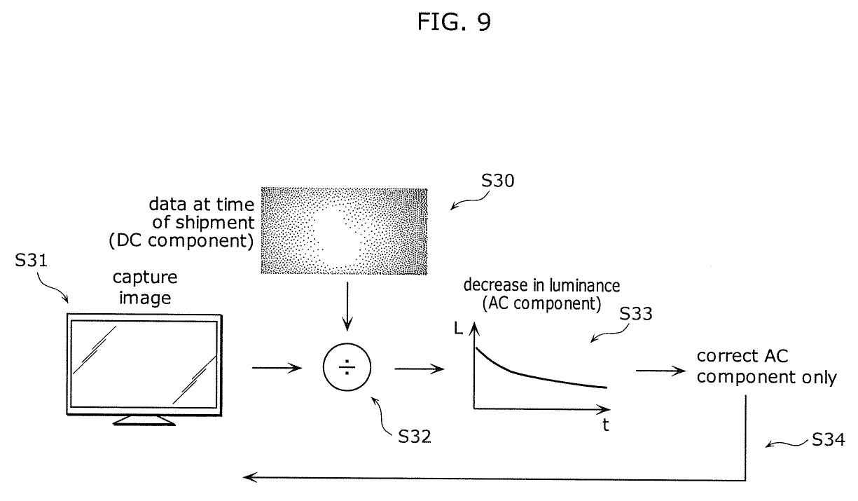

FIG. 9 is a view illustrating a processing flow of the calibration method in which the luminance unevenness is divided into the permanent component and the temporal component by server 50 in FIG. 1.

First, reference data 14 illustrating the spatial distribution of the luminance (that is, the luminance unevenness) in the initial state of display device 20 (for example, at the time of shipment from a factory) is stored in storage 55 of server 50 (S30). For example, before the shipment of display device 20 from the factory, the spatial distribution of the luminance is measured using a high-accuracy calibration device, and stored in storage 55 as reference data 14. Alternatively, for example, the user who purchases display device 20 causes display device 20 to display image for correction 11 used to calibrate the luminance unevenness at beginning of the use of display device 20, and captures displayed image for correction 11 using capture unit 31 of capture device 30, and uploads captured image for correction 11 onto server 50, whereby reference data 14 as the initial value is stored in storage 55. Reference data 14 is information indicating the permanent component (a so called DC component) related to the luminance unevenness of display device 20.

When the time of calibrating the luminance unevenness of display device 20 arrives, image for correction 11 identical to that used to acquire reference data 14 is displayed on display device 20, displayed image for correction 11 is captured by capture unit 31 of capture device 30, and obtained captured image 13 is transmitted to server 50 by uploader 35a (S31).

Then, in server 50 that receives captured image 13, calculating unit 53a calculates the spatial luminance unevenness of the currently- received captured image 13 based on reference data 14 stored in storage 55 (S32), generates correction data 12, and stores generated correction data 12 in storage 55 while correlating generated correction data 12 with generation timing. Specifically, the group of the correction coefficients (or reciprocals of the correction coefficients) obtained by dividing the pixel value of captured image 13 at the identical position by the pixel value of reference data 14 in units of pixels (or pixel blocks) is generated as correction data 12, and stored in storage 55 while correlating generated correction data 12 with the generation timing. The correction data is information indicating the temporal component (a so called AC component) related to the luminance unevenness of display device 20.

For example, the calibration of the luminance unevenness (S31, S32) is repeated at regular intervals (S33). Consequently, the change in the display characteristic of display device 20 with time (in this case, the decrease in luminance) can be checked by causing display 54 to display the change in the display characteristic.

The correction data obtained by the calibration of the luminance unevenness is transferred to display device 20 through communicator 51 by correction data transmission unit 53b of server 50, and written in storage 25 of display device 20 (S34).

As described above, in the calibration of the luminance unevenness using the reference data 14, reference data 14 is the initial value indicating the spatial distribution of the luminance of display device 20, and server 50 generates correction data 12 by calculating the spatial luminance unevenness based on the initial value with respect to the image acquired from capture device 30.

Consequently, the luminance unevenness is divided into the permanent component and the temporal component, the permanent component is accurately calibrated using the data of display device 20 at the time of shipment from the factory, the temporal component is easily calibrated through capture device 30 such as a smartphone, and the high-accurate calibration in which the fine luminance unevenness can be corrected is performed as a whole.

Additional service of display calibration system 10 by accumulating captured image 13 transmitted from capture device 30 in server 50 will be described below.

The display characteristic (for example, the luminance) of display device 20 may change suddenly when the user exchanges display device 20. First, service moderating the change will be described as first additional service.

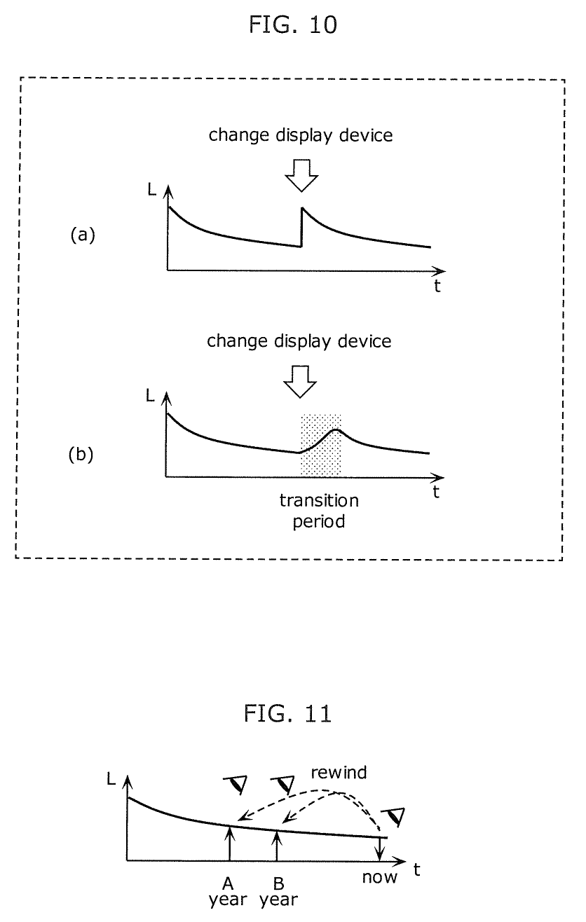

FIG. 10 is a view illustrating the additional service performed by display calibration system 10 in FIG. 1, and illustrating the service moderating the sudden change in display characteristic of display device 20 when display device 20 is exchanged.

In the display calibration system 10, server 50 repeatedly accumulates captured image 13 acquired from capture device 30 and identification information 29a in storage 55 together with the time information indicating the acquired date and time and the correction data obtained by the calibration while correlating captured image 13 and identification information 29a with display device 20 identified by identification information 29a. For each display device 20, server 50 can manage the aging of the display characteristic of display device 20 (for example, displays the aging on display 54) based on accumulated captured image 13 and the time information.

At this point, server 50 can identify the user of capture device 30 that transmits captured image 13, and accumulate and manage the display characteristic of display device 20 used by the user for each user. A part (a) of FIG. 10 illustrates an example of the aging of the display characteristic (in this case, the luminance) in the case where display device 20 used by one user is exchanged. As can be seen from the part (a) of FIG. 10, the display characteristic changes greatly when display device 20 is exchanged.

When display device 20 is exchanged, server 50 can provide the service moderating the sudden change in display characteristic of display device 20. Specifically, because server 50 accumulates, in storage 55, the display characteristic of display device 20 before exchange, the display characteristic of display device 20 after the exchange is calibrated such that the display characteristic of display device 20 after the exchange changes gradually from the display characteristic of display device 20 before the exchange. More specifically, with respect to display device 20 owned by the identical user, calculating unit 53a of server 50 generates correction data 12 by calibrating the display characteristic every time captured image 13 is uploaded. At this point, larger weighting is provided to the accumulated past display characteristic as the display characteristic becomes more recent, and new correction data 12 is generated by a calculation method influenced by the past display characteristic. Correction data transmission unit 53b of server 50 transmits generated correction data 12 to display device 20. Consequently, the correction data of display device 20 is updated. A part (b) of FIG. 10 illustrates an example of the aging of the display characteristic (in this case, the luminance) in the case where display device 20 used by one user is exchanged upon receiving the calibration by the additional service of server 50. As can be seen from the part (b) of FIG. 10, the display characteristic changes gradually after display device 20 is exchanged. Consequently, even if the display characteristic is greatly changed in the case where the user exchanges display device 20, the eyes can adjust to the change by gradually changing the appearance.

In this way, server 50 repeatedly accumulates the image acquired from capture device 30 together with the time information indicating the acquired date and time while correlating the image with display device 20 that displays the image.

Consequently, the image illustrating the display characteristic of display device 20 is accumulated in server 50 while correlated with the date and time, so that the high value added service can be provided using the accumulated images.

Server 50 displays the aging of the display characteristic of display device 20 based on the accumulated images and the time information.

Consequently, server 50 displays the aging of the display characteristic of display device 20, so that performance degradation of display device 20 can be recognized at a glance.

Service that assists the user to exchange display device 20 for a display device having the display characteristic close to that of display device 20 before exchange will be described below as second additional service.

Server 50 accumulates captured image 13 uploaded from capture device 30, the upload time information, the correction data obtained by the calibration, and the like in storage 55 for each user and each display device 20, thereby managing the aging of the display characteristic of display device 20. Thus, when receiving access from the communication device of the user, server 50 can present a product name, a manufacturing lot, an individual, and the like of another display device having the display characteristic close to that of display device 20 currently owned by the user. Specifically, server 50 holds a database indicating the product name, the manufacturing lot, and the display characteristic of the individual of the display devices of each of various manufacturers in storage 55. By referring to the database or by referring to another server holding the database through communicator 51, server 50 searches the product name, the manufacturing lot, the individual, and the like of another display device having the display characteristic close to that of display device 20 currently owned by the user, and presents a search result to the user. Consequently, the user can know the display device having the display characteristic close to that of display device 20 before the exchange when exchanging display device 20, so that the user can purchase and exchange the new display device.

Service that assists reproduction of the appearance of display device 20, which is viewed at a certain time and at a certain place by the user, at another time and at another place will be described below as third additional service.

FIG. 11 is a view illustrating the additional service performed by display calibration system 10 in FIG. 1, and illustrating the service that assists the reproduction of the appearance of display device 20, which is viewed at a certain time and at a certain place by a user, at another time and at another place. An example of the aging including a plurality of time points (A year, B year, now) with respect to the display characteristic (in this case, the luminance) of one display device 20 is illustrated in FIG. 11.

Server 50 accumulates captured image 13 uploaded from capture device 30, the upload time information, correction data 12 obtained by the calibration, and the like in storage 55 for each user and each display device 20, thereby managing the aging of the display characteristic of display device 20. Thus, when a certain time point in the past is designated by the user, server 50 reads correction data 12 indicating the display characteristic at that time from storage 55, and transmits correction data 12 to display device 20 using correction data transmission unit 53b. Consequently, the correction data of display device 20 is updated to the correction data at a certain time point in the past, and the display characteristic of display device 20 at a certain time point in the past is reproduced.

Consequently, the appearance of display device 20 seen at a certain place and at a certain time by the user can be reproduced at another time and at another place (that is, as if a video is rewound to a past state). For example, the service can be used for storing a diagnostic record of medical monitor and traceability.

Service predicting the change in display characteristic of display device 20 will be described below as fourth additional service.

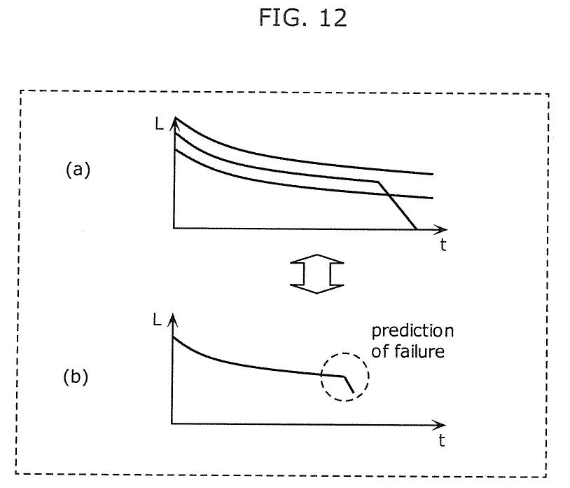

FIG. 12 is a view illustrating the additional service performed by display calibration system 10 in FIG. 1, and illustrating the service predicting the change in display characteristic of display device 20.

Server 50 accumulates captured image 13 uploaded from capture device 30, the upload time information, correction data 12 obtained by the calibration, and the like in storage 55 for many users (that is, many display devices 20), thereby managing the aging of the display characteristic for many display devices 20. A part (a) of FIG. 12 is a view illustrating the aging of the display characteristic (in this case, the luminance) of many display devices 20. In the part (a) of FIG. 12, a portion descending suddenly in a curve illustrating the display characteristic indicates a phenomenon generated immediately before a failure of display device 20.

Server 50 predicts the change in display characteristic of individual display devices 20 by statistically analyzing the accumulated display characteristic of many display devices 20. A part (b) of FIG. 12 is a view illustrating an example of the change in display characteristic of display device 20 predicted by server 50. Specifically, server 50 calculates an average period from the beginning of the use until the display characteristic is suddenly degraded only for the display characteristics of display devices 20 in which the manufacturer, the product name, the lot, and the like are in common, which allows the prediction of a life, the timing of failure, or the exchange timing of such types of display device 20.

In this way, server 50 predicts the change in display characteristic of display device 20 based on the accumulated captured image and time information.

Consequently, the value added service such as the prediction of the life of display device 20, the prediction of the failure, and notification of the exchange timing can be provided.

The service relating to foreign object detection will be described below as fifth additional service.

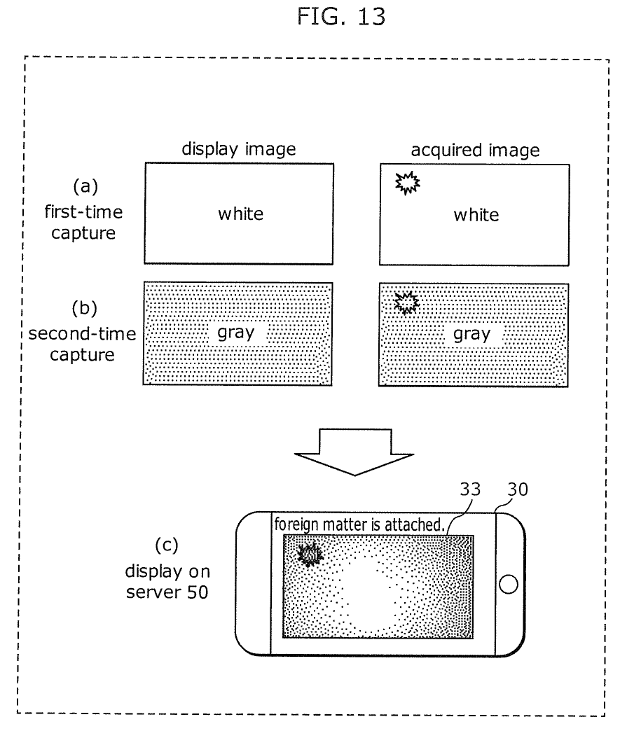

FIG. 13 is a view illustrating the additional service performed by display calibration system 10 in FIG. 1, and illustrating the foreign matter detection.

FIG. 13 is a view illustrating a foreign matter detection function of server 50 in FIG. 4. At this point, the procedure for foreign matter detection ((a) first time image capturing, (b) second-time image capturing, (c) display on server 50) is illustrated in FIG. 13.

First, as the “first-time image capturing” step, capture unit 31 of capture device 30 captures a first image (in this case, a white image) while the first image is displayed on display device 20, and the obtained first image is uploaded from capture device 30 onto server 50, and stored in storage 55 of server 50 (the part (a) of FIG. 5).

First, as the “second-time image capturing” step, capture unit 31 of capture device 30 captures a second image (in this case, a gray image) while the second image is displayed on display device 20, and the obtained second image is uploaded from capture device 30 onto server 50, and stored in storage 55 of server 50 (the part (b) of FIG. 5).

The image capturing of different images as described above is not limited to twice, but may be any number of three or more times.

Finally, as the step of performing the “display on server 50”, server 50 determines, from the plurality of images (in this case, the first and second images stored in storage 55) captured by capture unit 31, whether the identical display object exists at the common position in these images, thereby detecting that the foreign matter adheres to the screen of display device 20 or capture unit 31 to present the adhesion of the foreign matter to the user (the part (c) of FIG. 5).

Specifically, server 50 performs image processing such as outline extraction extracting regions having spatially different luminances on each of the plurality of images read from storage 55, and determines whether the luminance of the extracted region changes relatively in the plurality of images. As a result, a determination is made that the “luminance unevenness” is generated for the region where the luminance changes relatively. On the other hand, a determination is made that the “foreign matter” adheres for the region where the luminance does not relatively change, and the determination result is presented on display 54. The determination result may be displayed on capture device 30 by downloading the determination result from server 50 to capture device 30. Consequently, the user who views display 54 of server 50 or display 33 of capture device 30 can know that the foreign matter adheres to the screen of display device 20 or capture unit 31 in the case where the foreign matter adheres.

As described above, in the foreign matter detection, display device 20 switches and displays the plurality of different images, and capture device 30 captures the plurality of images displayed on display device 20. Server 50 acquires the plurality of images captured by capture unit 31, and determines, from the plurality of acquired images, whether the identical display object exists at the common position in the plurality of images, thereby detecting the adhesion of the foreign matter to the screen of display device 20 or capture unit 31 to present the adhesion of the foreign matter to the user.

Consequently, the adhesion of the foreign matter to the screen of display device 20 or capture unit 31 is detected, so that the high-accuracy calibration of the luminance unevenness is secured by removing the foreign matter in the case where the adhesion of the foreign matter is detected.

A calibration jig that calibrates the luminance of capture unit 31 of capture device 30 will be described below as an accessory of display calibration system 10.

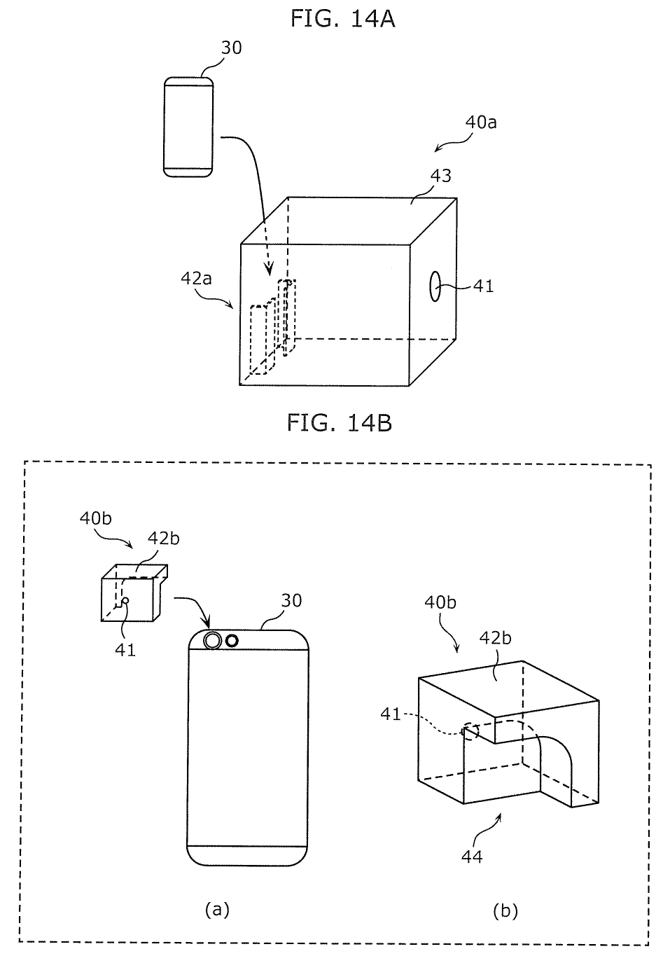

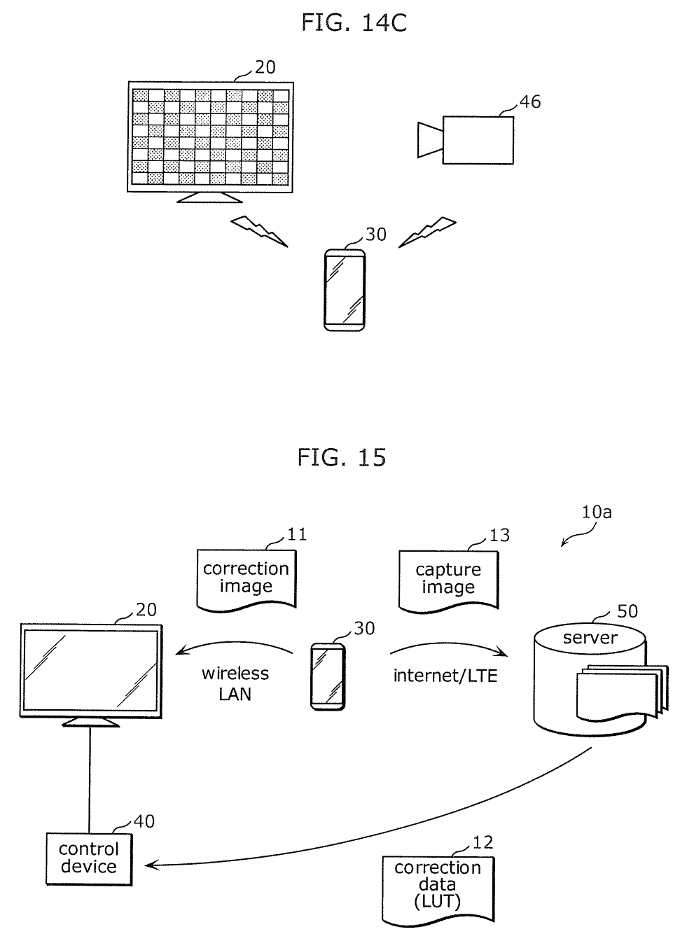

FIG. 14A is an external view illustrating an example (calibration jig 40a ) of the calibration jig for calibrating the luminance of capture unit 31 of capture device 30 in FIG. 3.

Calibration jig 40a is configured with light source 41 having known luminance, positioning unit 42a that is a structure that positions capture unit 31 with respect to light source 41, and casing 43 in which light source 41 and positioning unit 42a are accommodated.

Casing 43 is a box body made of corrugated cardboard that is sealed so as to prevent light from entering the inside of the box body from the outside.

Light source 41 is attached to an inside surface of one surface of the casing 43 and emits light having the known (that is, constant) luminance toward an opposing inside surface. For example, light source 41 is configured with a battery, a constant-current circuit that outputs constant current with electric power as input, and an LED to which the current from the constant-current circuit is applied.

Positioning unit 42a is a positioning guide that fixes capture device 30 to the inside (the inside surface opposed to light source 41) of casing 43 such that the light emitted from light source 41 is incident on an incident port of capture unit 31 of capture device 30.

With this calibration jig 40a, an imaging characteristic of capture unit 31 of capture device 30 can be calibrated using light source 41 having the known luminance, and the calibration by capture device 30 is secured with high accuracy.

Because calibration jig 40a is provided with the positioning guide that fixes capture unit 31 to the inside of casing 43, a positional relationship between light source 41 and capture unit 31 is easily and certainly fixed, and the calibration work for capture unit 31 of capture device 30 becomes easy and accurate.

FIG. 14B is an external view illustrating another example (calibration jig 40b) of the calibration jig for calibrating the luminance of capture unit 31 of capture device 30 in FIG. 3.

Calibration jig 40b is configured with light source 41 having the known luminance and positioning unit 42b that is a structure that positions capture unit 31 with respect to light source 41.

Light source 41 is similar to light source 41 of calibration jig 40a, and is a light source that emits the light having the known (that is, constant) luminance. For example, light source 41 is configured with a battery, a constant-current circuit that outputs constant current with electric power as input, and an LED to which the current from the constant current circuit is applied.

Positioning unit 42b is an attachment to which light source 41 is attached, and the attachment is detachably attached to capture unit 31. More specifically, positioning unit 42b is a box body to which light source 41 is attached, and includes recess 44 in which a corner portion of capture device 30 including capture unit 31 can be fitted. By fitting the corner portion of capture device 30 including capture unit 31 in recess 44 of positioning unit 42b, the light emitted from light source 41 can stably enter the incident port of capture unit 31.

As described above, calibration jig 40b includes light source 41 having the known luminance and positioning unit 42b that is the structure that positions capture unit 31 with respect to light source 41. Positioning unit 42b is an attachment that is detachably attached to capture unit 31.

Consequently, because calibration jig 40b includes the attachment that is detachably attached to capture unit 31, the positional relationship between light source 41 and capture unit 31 can easily and certainly be fixed only by attaching calibration jig 40b to capture unit 31, and the calibration work for capture unit 31 of capture device 30 can simply be performed. Thus, an expensive environment such as a dark room as in the conventional case becomes unnecessary.

FIG. 14C is a view illustrating a system configuration in which a calibrated camera or a calibrated luminance meter (in this case, calibrated luminance meter 46) is used as the calibration jig for calibrating the luminance or the luminance unevenness of capture unit 31 of the capture device 30 in FIG. 3.

Luminance meter 46 is an accessory of display calibration system 10, is a calibrated measurement device that measures the luminance of the image for calibration displayed on display device 20, and has a function of communicating with capture device 30. Luminance meter 46 is not limited to a dedicated measuring device, but may be a calibrated camera. The image for calibration displayed on display device 20 may be identical to image for correction 11 used to calibrate display device 20, or may be a dedicated image used to calibrate capture unit 31. For example, the image for calibration is an image in which all the pixels have the identical pixel value.

In capture device 30, similarly to luminance meter 46, capture unit 31 captures the image for calibration displayed on display device 20. Controller 35 acquires data indicating the luminance measured by luminance meter 46 from luminance meter 46 through communicator 34, and calibrates capture unit 31 using the acquired data. Specifically, controller 35 calculates the average luminance using at least one representative point of the image for calibration captured by capture unit 31, and performs the luminance calibration or color calibration such that the calculated average luminance becomes the luminance indicated by the data acquired from luminance meter 46.

As described above, display calibration system 30 includes the calibrated camera that captures the image displayed on display device 20 or the calibrated luminance meter that measures the luminance as the accessory. Controller 35 of capture device 30 acquires the data from the accessory via the communicator 34 and calibrates the luminance of capture unit 31 using the acquired data.

Consequently, the luminance calibration can be performed on capture unit 31 of capture device 30 using calibrated luminance meter 46, and the luminance calibration for display device 20 by capture device 30 is secured with high accuracy.

As described above, display calibration system 10, display device 20, capture device 30, server 50, and the method for calibrating display device 20 of the present disclosure are described based on the exemplary embodiment. However, the present disclosure is not limited to the exemplary embodiment. It is understood that various modifications to the exemplary embodiment and the modification that are conceived by those skilled in the art, and other exemplary embodiments obtained by a combination of components of the exemplary embodiment and the modification are also included within the scope of the present disclosure without departing from the scope of the present disclosure.

For example, in the exemplary embodiment, correction data 12 generated by server 50 is downloaded to display device 20 through capture device 30. However, correction data 12 is not limited to this route, but may be downloaded from server 50 to display device 20 with no use of capture device 30, or downloaded to the control device connected to display device 20.

FIG. 15 is a configuration diagram illustrating display calibration system 10a according to a modification of the exemplary embodiment. At this point, an example in which correction data 12 generated by server 50 is downloaded to control device 39 connected to display device 20 is illustrated in FIG. 15.

Control device 39 is a device, which is connected to server 50 through the communication path such as the Internet and uses display device 20 as an image output device. For example, control device 39 is a computer main body, a TV tuner device, or a medical image processing device. Control device 39 is connected to display device 20, acquires correction data 12 from server 50 through the communication path, corrects the input image using acquired correction data 12, and outputs the corrected image to display device 20.

Consequently, correction data 12 held by control device 39 that uses display device 20 as the image output device is updated by correction data 12 obtained by the calibration performed by server 50. Thus, the image corrected by control device 39 using updated correction data 12 is displayed on display device 20, and updated correction data 12 is utilized by control device 39.

In the exemplary embodiment, capture device 30 is the portable information terminal, such as a smartphone and a tablet terminal, in which the camera is incorporated. However, the present disclosure is not limited to this configuration, and capture device 30 may be a stationary type device configured with the camera and the computer device as long as capture device 30 captures the image displayed on display device 20 to transmit the image to server 50. By cooperating with server 50, the display characteristic of display device 20 can be calibrated at lower cost and fewer man-hours than before.

In the exemplary embodiment, the luminance calibration and the calibration of the luminance unevenness are performed by server 50. However, it is not always necessary to perform the luminance calibration and the calibration of the luminance unevenness. One of the luminance calibration and the calibration of the luminance unevenness may be performed.

In the exemplary embodiment, capture device 30 transmits, to display device 20, image for correction 11 to be displayed on display device 20. However, this transmission is not necessarily required. For example, display device 20 may display the image for correction previously stored in display device 20, the image for correction read from an auxiliary storage device such as a USB memory, or the image for correction acquired from an external device through the Internet or the like.

In the exemplary embodiment, controller 35 of capture device 30 includes uploader 35a, downloader 35b, image for correction instruction unit 35c, and imaging controller 35d. However, controller 35 does not necessarily include all of these components. Downloader 35b, image for correction instruction unit 35c, and imaging controller 35d may be implemented by an application added as an option as necessary.

In the above exemplary embodiment, storage 55 of server 50 holds reference data 14. However, storage 55 does not necessarily hold reference data 14. In the case of the calibration of the luminance unevenness and the like, server 50 can calibrate captured image 13 transmitted from capture device 30 without using reference data 14.

In the exemplary embodiment, storage 25 of display device 20 includes first storage 25a that stores previously-provided correction data 12a and second storage 25b that stores correction data 12b transmitted from capture device 30. Alternatively, storage 25 may further include a storage dedicated for backup and a storage that holds the image for correction.

What is claimed is:

1. A display calibration system that calibrates a display characteristic of a display device, the display calibration system comprising:
a display device that displays an image;
an capture device that captures the image displayed on the display device; and
a server connected to the capture device through a communication path, the server acquiring the image captured by the capture device through the communication path, generating correction data used to correct the display characteristic of the display device by performing arithmetic operation of the acquired image, and transmitting the generated correction data to the display device or a control device connected to the display device through the communication path.

2. The display calibration system according to claim 1, wherein the server generates the correction data by performing arithmetic operation on luminance of at least one representative point of the image acquired from the capture device using a reference value of the luminance at the representative point.

3. The display calibration system according to claim 1, wherein the server generates the correction data by performing arithmetic operation to calculate spatial luminance unevenness on the image acquired from the capture device.

4. The display calibration system according to claim 1, wherein
the capture device transmits a image for correction to the display device,
the display device acquires and displays the image for correction transmitted from the capture device, and
the capture device captures the image for correction displayed on the display device.

5. The display calibration system according to claim 1, wherein the display device acquires the correction data from the server through the communication path, and corrects and displays an input video signal using the acquired correction data.

6. The display calibration system according to claim 1, further comprising a control device connected to the display device, the control device acquiring the correction data from the server through the communication path, correcting the input image using the acquired correction data, and outputting the corrected image to the display device.

7. The display calibration system according to claim 1, wherein
the capture device captures the image displayed on the display device from a plurality of viewpoints, and
the server acquires a plurality of images captured from the plurality of viewpoints by the capture device, synthesizes the plurality of acquired images, and generates the correction data using the image obtained by the synthesis.

8. The display calibration system according to claim 1, wherein
the display device presents identification information identifying the display device,
the capture device acquires the identification information presented by the display device, and
the server acquires the identification information from the capture device, and generates the correction data while correlating the correction data with the acquired identification information.

9. The display calibration system according to claim 8, wherein the display device presents the identification information by transmitting the identification information by visible-light communication, displaying the identification information with a bar code, or transmitting the identification information by wireless communication.

10. The display calibration system according to claim 8, wherein the server holds a plurality of pieces of reference data,
the server selects a part of the plurality of pieces of reference data based on the identification information acquired from the capture device, and
the server generates the correction data by performing arithmetic operation on the image acquired from the capture device using the part of the plurality of pieces of reference data.

11. The display calibration system according to claim 1, wherein the server holds reference data indicating the display characteristic of the display device, and generates the correction data by performing arithmetic operation on the image acquired from the capture device using the reference data,
wherein the reference data is an initial value indicating a spatial distribution of luminance of the display device, and
the server generates the correction data by calculating spatial luminance unevenness of the image acquired from the capture device based on the initial value.

12. The display calibration system according to claim 1, wherein the server repeatedly accumulates the image acquired from the capture device while correlating the image with the display device that displays the image together with time information indicating acquired date and time.

13. The display calibration system according to claim 12, wherein the server displays aging of the display characteristic of the display device based on the accumulated image and the time information.

14. The display calibration system according to claim 13, wherein the server predicts a change in display characteristic of the display device based on the accumulated image and the time information.

15. The display calibration system according to claim 1, wherein
the display device switches and displays a plurality of different images,
the capture device captures the plurality of images displayed on the display device, and
the server further includes a foreign matter detector that detects a foreign matter adhering to a screen of the display device or the capture device by determining whether an identical display object exists at a common position in the plurality of images from the plurality of acquired images and presents the adhesion of the foreign matter to a user.

16. The display calibration system according to claim 1, further comprising a calibration jig that calibrates the capture unit,
wherein the calibration jig includes:
a light source; and
a positioning unit that is a structure that positions the capture unit with respect to the light source,
wherein the capture device is a portable information terminal including an capture unit.

17. The display calibration system according to claim 16, wherein
the calibration jig further includes a casing in which the light source and the capture unit are accommodated, and
the positioning unit is a positioning guide that fixes the capture unit into the casing.

18. A display device constituting the display calibration system according to claim 1, the display device comprising:
a communicator that communicates with the capture device constituting the display calibration system according to claim 1;
a video signal generator that acquires an image transmitted from the capture device through the communicator and generates a video signal indicating the acquired image;
a video signal processor including a correction data storage that acquires and stores correction data transmitted from the capture device through the communicator, the video signal processor correcting the video signal generated by the video signal generator using the correction data stored in the correction data storage; and
a display panel that displays the video signal corrected by the video signal processor.

19. The display device according to claim 18, wherein the correction data storage has a storage capacity in which at least two pieces of correction data indicating different corrections are stored,
wherein the correction data storage includes a first storage in which previously-provided correction data is stored and a second storage in which correction data transmitted from the capture device is stored.

20. An capture device constituting the display calibration system according to claim 1, the capture device comprising:
an capture unit that captures an image displayed on the display device constituting the display calibration system according to claim 1;
a communicator that communicates with the display device or the control device connected to the display device and the server constituting the display calibration system according to claim 1; and
a controller that controls the capture unit and the communicator,
wherein the controller includes:
an uploader that transmits the image captured by the capture unit to the server through the communicator; and
a downloader that transfers the correction data transmitted from the server through the communicator to the display device or the control device.
